(19) United States
(12) Patent Application Publication
(10) Pub. No.: US 2017/0323157 A1
(43) Pub. Date: Nov. 9, 2017

(54) SYSTEM AND METHOD FOR DETERMINING AN ENTITY STATUS BASED ON UNSTRUCTURED ELECTRONIC DOCUMENTS

(71) Applicant: Vatbox, Ltd., Herzeliya (IL)

(72) Inventors: Noam GUZMAN, Ramat Hasharon (IL); Isaac SAFT, Kfar Neter (IL)

(73) Assignee: Vatbox, Ltd., Herzeliya (IL)

(21) Appl. No.: 15/597,825

(22) Filed: May 17, 2017

Related U.S. Application Data
(63) Continuation-in-part of application No. 15/361,934, filed on Nov. 28, 2016.
(60) Provisional application No. 62/337,888, filed on May 18, 2016.
(60) Provisional application No. 62/260,553, filed on Nov. 29, 2015.
(60) Provisional application No. 62/261,355, filed on Dec. 1, 2015.

(51) Int. Cl. G06K 9/00; G06F 17/24; G06F 17/30; G06Q 40/00

(52) U.S. Cl. CPC G06K 9/00469; G06F 17/30011; G06K 9/00442; G06F 17/248; G06Q 40/00; G06K 9/00

(57) ABSTRACT

A system and method for determining an entity status based on unstructured electronic documents. The method includes analyzing a transaction electronic document to determine at least one transaction parameter for the transaction electronic document, wherein the transaction electronic document includes at least partially unstructured data; creating a template for the transaction electronic document, wherein the template is a structured dataset including the determined at least one transaction parameter; obtaining, based on the created template, an evidencing electronic document, wherein the evidencing electronic document at least indicates a status of an entity indicated in the transaction electronic document at a time indicated in the electronic document; and determining, based on the obtained evidencing electronic document, the status of the entity, wherein the determined status indicates whether the entity was authentic at the time indicated in the electronic document.

### CROSS-REFERENCE TO RELATED APPLICATIONS

This application claims the benefit of U.S. Provisional Application No. 62/337,888 filed on May 18, 2016. This application is also a continuation-in-part of U.S. patent application Ser. No. 15/361,934 filed on Nov. 28, 2016, now pending, which claims the benefit of U.S. Provisional Application No. 62/260,553 filed on Nov. 29, 2015, and of U.S. Provisional Application No. 62/261,355 filed on Dec. 1, 2015. The contents of the above-referenced applications are hereby incorporated by reference.

### TECHNICAL FIELD

The present disclosure relates generally to analyzing electronic documents, and more particularly to determining an entity status based on electronic documents.

### BACKGROUND

Customers can place orders for services such as travel and accommodations from merchants in real-time over the web. These orders can be received and processed immediately. However, payments for the orders typically require more time to complete and, in particular, to secure the money being transferred. Therefore, merchants typically require the customer to provide assurances of payment in real-time while the order is being placed. As an example, a customer may input credit card information pursuant to a payment, and the merchant may verify the credit card information in real-time before authorizing the sale. The verification typically includes determining whether the provided information is valid (i.e., that a credit card number, expiration date, PIN code, and/or customer name match known information).

Upon receiving such assurances, a purchase order may be generated for the customer. The purchase order provides evidence of the order such as, for example, a purchase price, goods and/or services ordered, and the like. Later, an invoice for the order may be generated. While the purchase order is usually used to indicate which products are requested and an estimate or offering for the price, the invoice is usually used to indicate which products were actually provided and the final price for the products. Frequently, the purchase price as demonstrated by the invoice for the order is different from the purchase price as demonstrated by the purchase order. As an example, if a guest at a hotel initially orders a 3-night stay but ends up staying a fourth night, the total price of the purchase order may reflect a different total price than that of the subsequent invoice. Cases in which the total price of the invoice is different from the total price of the purchase order are difficult to track, especially in large enterprises accepting many orders daily (e.g., in a large hotel chain managing hundreds or thousands of hotels in a given country). The differences may cause errors in recordkeeping for enterprises.

As businesses increasingly rely on technology to manage data related to operations such as invoice and purchase order data, suitable systems for properly managing and collecting data have become crucial to success. Particularly for large businesses, the amount of data utilized daily by businesses can be overwhelming. Accordingly, manual review and collection of such data is impractical, at best.

Some solutions exist for automatically recognizing information in scanned documents (e.g., invoices and receipts) or other unstructured electronic documents (e.g., unstructured text files). Such solutions often face challenges in accurately identifying and recognizing characters and other features of electronic documents. Moreover, degradation in content of the input unstructured electronic documents typically result in higher error rates. As a result, existing image recognition techniques are not completely accurate under ideal circumstances (i.e., very clear images), and their accuracy often decreases dramatically when input images are less clear. Moreover, missing or otherwise incomplete data can result in errors during subsequent use of the data. Many existing solutions cannot identify missing data unless, e.g., a field in a structured dataset is left incomplete.

In addition, existing image recognition solutions may be unable to accurately identify some or all special characters (e.g., “!,” “@,” “#,” “$,” “©,” “%,” “&,” etc.). As an example, some existing image recognition solutions may inaccurately identify a dash included in a scanned receipt as the number “1.” As another example, some existing image recognition solutions cannot identify special characters such as the dollar sign, the yen symbol, etc.

Further, to successfully reclaim value-added taxes paid during a transaction, enterprises seeking reclaims must typically provide evidentiary proof of the transaction. Such evidentiary proof must demonstrate that the transaction involved a seller that was valid at least as of the time of the transaction. If such a seller did not exist, the reclaim is unsuccessful. However, for various reasons, suppliers may cease existing after a transaction has occurred. In such instances, it must be determined whether the supplier existed and/or was registered for reclaims (e.g., with an appropriate tax authority). This determination often requires inquiring into the status of the supplier and, further, checking historical information of the supplier.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Certain embodiments disclosed herein include a method for determining an entity status based on at least partially unstructured electronic documents. The method comprises: analyzing a transaction electronic document to determine at least one transaction parameter for the transaction electronic document, wherein the transaction electronic document includes at least partially unstructured data; creating a template for the transaction electronic document, wherein the template is a structured dataset including the determined at least one transaction parameter; obtaining, based on the created template, an evidencing electronic document, wherein the evidencing electronic document at least indicates a status of an entity indicated in the transaction electronic document at a time indicated in the electronic document; and determining, based on the obtained evidencing electronic document, the status of the entity, wherein the determined status indicates whether the entity was authentic at the time indicated in the electronic document.

Certain embodiments disclosed herein also include a non-transitory computer readable medium having stored thereon instructions for causing a processing circuitry to perform a process, the process comprising: analyzing a transaction electronic document to determine at least one transaction parameter for the transaction electronic document, wherein the transaction electronic document includes at least partially unstructured data; creating a template for the transaction electronic document, wherein the template is a structured dataset including the determined at least one transaction parameter; obtaining, based on the created template, an evidencing electronic document, wherein the evidencing electronic document at least indicates a status of an entity indicated in the transaction electronic document at a time indicated in the electronic document; and determining, based on the obtained evidencing electronic document, the status of the entity, wherein the determined status indicates whether the entity was authentic at the time indicated in the electronic document.

Certain embodiments disclosed herein also include a system for determining an entity status based on at least partially unstructured electronic documents. The system comprises: a processing circuitry; and a memory, the memory containing instructions that, when executed by the processing circuitry, configure the system to: analyze a transaction electronic document to determine at least one transaction parameter for the transaction electronic document, wherein the transaction electronic document includes at least partially unstructured data; create a template for the transaction electronic document, wherein the template is a structured dataset including the determined at least one transaction parameter; obtain, based on the created template, an evidencing electronic document, wherein the evidencing electronic document at least indicates a status of an entity indicated in the transaction electronic document at a time indicated in the electronic document; and determine, based on the obtained evidencing electronic document, the status of the entity, wherein the determined status indicates whether the entity was authentic at the time indicated in the electronic document.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a schematic diagram of a status analyzer according to an embodiment.

FIG. 3 is a flowchart illustrating a method for determining an entity status based on at least partially unstructured electronic documents according to an embodiment.

FIG. 4 is a flowchart illustrating a method for creating a dataset based on at least one electronic document according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for determining an entity status based on at least partially unstructured electronic documents. In an embodiment, a dataset is created based on an electronic document indicating transaction information. A template of transaction attributes is created based on the electronic document dataset. The template is a structured dataset created based on at least partially unstructured data generated via machine imaging of the electronic documents.

Based on the created templates, at least an entity and a time of the transaction are identified. The entity and time may be indicated in corresponding fields of the template. Based on the identified entity and time, an electronic document indicating a status of the supplier is determined. The status of the entity may be identified in the obtained electronic document, and may indicate whether the entity was a legitimate entity as of the time of the transaction. The obtained electronic document and the identified status may be stored in a storage, thereby serving as evidence of the status of the entity as of the time of the transaction.

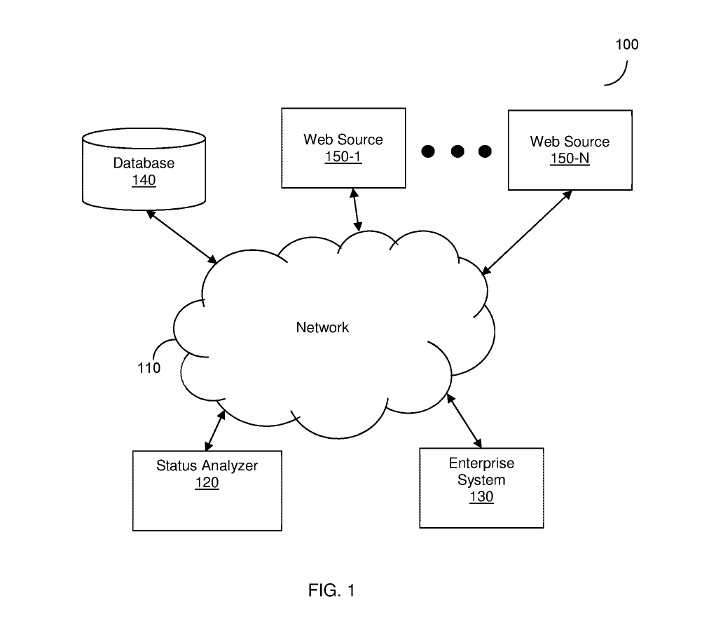

FIG. 1 shows an example network diagram 100 utilized to describe the various disclosed embodiments. In the example network diagram 100, a status analyzer 120, an enterprise system 130, a database 140, and a plurality of web sources 150-1 through 150-N (hereinafter referred to individually as a web source 150 and collectively as web sources 150, merely for simplicity purposes), are communicatively connected via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The enterprise system 130 is associated with an enterprise, and may store data related to transactions involving the enterprise or representatives of the enterprise as well as data related to the enterprise itself. The enterprise may be, but is not limited to, an enterprise such as a business whose employees may purchase goods and services pursuant to their roles and responsibilities. The enterprise system 130 may be, but is not limited to, a server, a database, an enterprise resource planning system, a customer relationship management system, or any other system storing relevant data.

The data stored by the enterprise system 130 may include, but is not limited to, electronic documents (e.g., an image file showing, for example, a scan of an invoice, a text file, a spreadsheet file, etc.). Each electronic document may show, e.g., an invoice, a tax receipt, a purchase number record, and the like. Data included in at least some of the electronic documents is at least partially unstructured such that the data may be structured, semi-structured, unstructured, or a combination thereof. The structured or semi-structured data may be in a format that is not recognized by the status analyzer 120 and, therefore, may be treated as unstructured data.

Each electronic document stored in the enterprise system 130 is related to a transaction. Consequently, the electronic documents may indicate at least expenses incurred by the enterprise during the transaction and other information related thereto. As a non-limiting example, an electronic document may indicate a type of good or service purchased (e.g., a hotel stay), a time of the transaction, a price per unit, a quantity, a buyer, a supplier (e.g., a seller or a manufacturer), supplier information (e.g., name, merchant registration number, etc.), combinations thereof, and the like.

The database 140 stores evidencing electronic documents indicating entity statuses used for providing evidence of entity statuses to, e.g., tax authorities. The database 140 may further store status identifiers indicating the status evidenced by each stored evidencing electronic document.

Each of the web sources 150 includes data indicating a status of one or more entities. In an example implementation, each web source 150 includes an image showing an entity status identifier and a time period for the status. The web sources 150 may include, but are not limited to, tax authority servers, accounting servers, and the like.

In an embodiment, the status analyzer 120 is configured to create templates based on transaction parameters identified using machine vision on at least partially unstructured electronic documents indicating information related to transactions. In a further embodiment, the status analyzer 120 may be configured to retrieve the transaction electronic documents from, e.g., the enterprise system 130. Alternatively or collectively, electronic documents may be received from client devices (not shown) utilized by employees or other representatives of the enterprise. Based on the created templates, the status analyzer 120 is configured to obtain evidencing electronic documents indicating a status of an entity indicated in a transaction electronic document as of the time of the transaction electronic document.

Each template is a structured dataset including the identified transaction parameters for a transaction. The transaction parameters indicate information related to the transaction that are indicated in the transaction electronic document such as, but not limited to, a type of good or service purchased (e.g., a hotel stay), a time of the transaction, a price per unit, a quantity, a buyer, a supplier (e.g., a seller or a manufacturer), supplier information (e.g., name, merchant registration number, etc.), and the like.

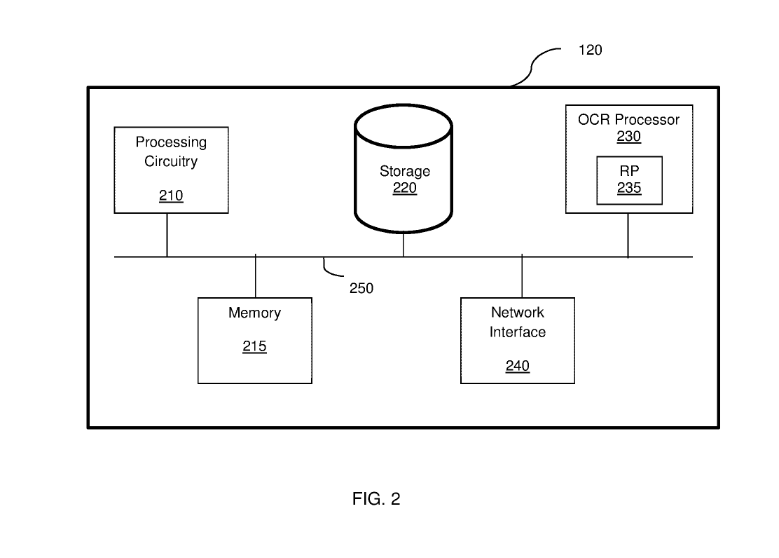

In an embodiment, the status analyzer 120 is configured to create datasets based on at least partially unstructured electronic documents including data at least partially lacking a known structure (e.g., unstructured data, semi-structured data, or structured data having an unknown structure). To this end, in a further embodiment, the status analyzer 120 may be further configured to utilize optical character recognition (OCR) or other image processing to determine data in the electronic document. The status analyzer 120 may therefore include or be communicatively connected to a recognition processor (e.g., the recognition processor 235, FIG. 2). Based on the datasets, the status analyzer 120 is configured to create the templates.

In another embodiment, the status analyzer 120 may be further configured to validate each analyzed electronic document based on its respective template. The validation may include, but is not limited to, determining whether each analyzed electronic document is complete and accurate.

Each analyzed electronic document may be determined to be complete if, for example, one or more predetermined reporting requirements is met (e.g., for a purchase, relevant requirements may include types of goods or services purchased, total price, quantity, supplier, etc.).

Each analyzed electronic document may be determined to be accurate based on data stored in at least one external source. The at least one external source may include, but is not limited to, one or more web sources or other data sources (not shown). As a non-limiting example, a merchant server of a merchant who was the seller in a transaction may be queried for metadata related to the electronic document associated with the transaction, and the metadata obtained via the query may be compared to data of the template for the electronic document. For example, the metadata obtained via the query may include a price of the transaction, a transaction identifier, and the like, which may be compared to data in corresponding fields of the template created for the transaction.

In an embodiment, the status analyzer 120 is configured to identify at least an entity and a time of the transaction based on the created template. In a further embodiment, the status analyzer 120 is configured to identify the entity and time based on transaction parameters in corresponding fields of the template. As a non-limiting example, the entity may be identified based on an entity identification number indicated by a transaction parameter in a “supplier ID” field of the template, and the time may be identified as the date indicated by a transaction parameter in a “date” field of the template.

In an embodiment, based on the identified entity and time, the status analyzer 120 is configured to obtain an evidencing electronic document indicating the identified entity of the supplier at the identified time as well as a status of an entity. In a further embodiment, the status analyzer 120 is configured to extract the evidencing electronic document. In yet a further embodiment, extracting the evidencing electronic document may include identifying an electronic document including the identified entity and time, and retrieving or capturing a screenshot of the identified electronic document to be utilized as the evidencing electronic document. As a non-limiting example, a web page hosted by the web source 150-3 may be identified as including the identified entity and time as well as indicating a status of a supplier, and a screenshot of the web page may be captured, where the screenshot is utilized as the evidencing electronic document.

In an embodiment, based on the evidencing electronic document, the status analyzer 120 is configured to determine a status of the entity. In a further embodiment, the status analyzer 120 may be configured to generate a status identifier indicating the determined status.

In an example implementation, the status of the entity may indicate whether the entity was a authentic entity as of the time of the transaction. An entity may be authentic at the time of the transaction if, for example, the entity was in existence (e.g., the entity is a company or a particular store of the company that was established and had not closed, entered bankruptcy, or been acquired prior to the time of the transaction), the entity had at least one predetermined required registration as of the time of the transaction (e.g., if the entity was a registered VAT merchant as required for obtaining VAT reclaims), or a combination thereof. To this end, in an embodiment, the generated status identifier may be or may include at least one of: existing, non-existing, registered, unregistered, and the like.

In an embodiment, the status analyzer 120 may be configured to analyze, via machine imaging, the evidencing electronic document, where the status is determined based on the analysis. In a further embodiment, the status analyzer 120 may be configured to create a template for the evidencing electronic document as described herein. The template for the evidencing electronic document may be created based on status evidence parameters indicated in the electronic document and a predetermined set of key fields and values, where the predetermined set of key fields and values for the evidencing electronic document template may be different from the predetermined set of key fields and values for the transaction electronic document template.

In an embodiment, the status analyzer 120 is configured to store the evidencing electronic document in the database 140. In a further embodiment, the status analyzer 120 may be further configured to store the generated status identifier in the database 140 with the corresponding evidencing electronic document. To this end, in yet a further embodiment, the status analyzer 120 may be configured to create a file including the evidencing electronic document and the status identifier, and to store the created file in the database 140.s

It should be noted that the embodiments described herein above with respect to FIG. 1 are described with respect to one enterprise system 130 merely for simplicity purposes and without limitation on the disclosed embodiments. Multiple enterprise systems may be equally utilized without departing from the scope of the disclosure.

FIG. 2 is an example schematic diagram of the status analyzer 120 according to an embodiment. The status analyzer 120 includes a processing circuitry 210 coupled to a memory 215, a storage 220, and a network interface 240. In an embodiment, the status analyzer 120 may include an optical character recognition (OCR) processor 230. In another embodiment, the components of the status analyzer 120 may be communicatively connected via a bus 250.

The processing circuitry 210 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 215 may be volatile (e.g., RAM, etc.), non-volatile (e.g., ROM, flash memory, etc.), or a combination thereof. In one configuration, computer readable instructions to implement one or more embodiments disclosed herein may be stored in the storage 220.

In another embodiment, the memory 215 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 210 to perform the various processes described herein. Specifically, the instructions, when executed, cause the processing circuitry 210 to determine an entity status based on at least partially unstructured electronic documents, as discussed herein.

The storage 220 may be magnetic storage, optical storage, and the like, and may be realized, for example, as flash memory or other memory technology, CD-ROM, Digital Versatile Disks (DVDs), or any other medium which can be used to store the desired information.

The OCR processor 230 may include, but is not limited to, a feature and/or pattern recognition processor (RP) 235 configured to identify patterns, features, or both, in at least partially unstructured data sets. Specifically, in an embodiment, the OCR processor 230 is configured to identify at least characters in the unstructured data. The identified characters may be utilized to create a dataset including data required for analyzing transactions and generating recommendations based thereon.

The network interface 240 allows the status analyzer 120 to communicate with the enterprise system 130, the database 140, the web sources 150, or a combination thereof, for purposes such as, for example, obtaining electronic documents, storing evidencing electronic documents and status identifiers, and the like.

It should be understood that the embodiments described herein are not limited to the specific architecture illustrated in FIG. 2, and other architectures may be equally used without departing from the scope of the disclosed embodiments.

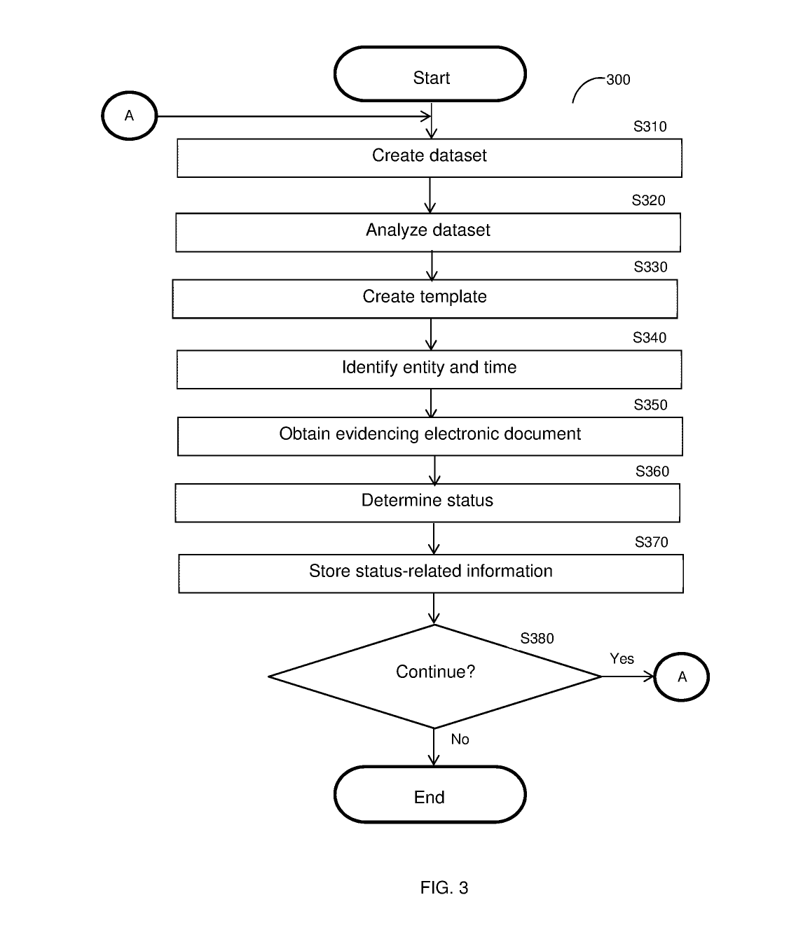

FIG. 3 is an example flowchart 300 illustrating a method for determining an entity status based on electronic documents according to an embodiment. In an embodiment, the method is performed by the status analyzer 120 based on a transaction electronic document indicating information related to a transaction.

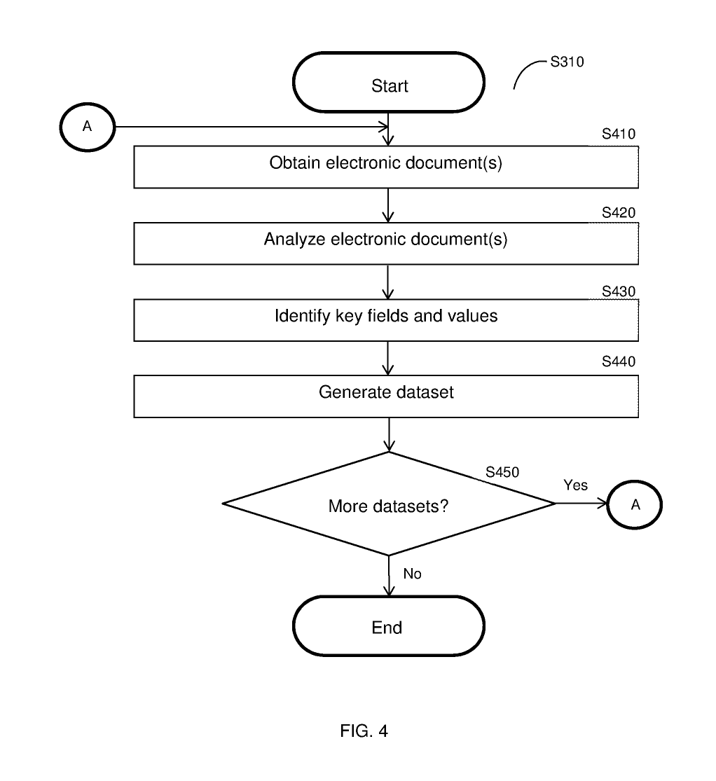

At S310, a dataset is created for the transaction electronic document. The electronic document indicates at least partially unstructured data of a transaction involving the enterprise and may include, but is not limited to, unstructured data, semi-structured data, structured data with structure that is unanticipated or unannounced, or a combination thereof. In an embodiment, S310 may further include analyzing each electronic document using optical character recognition (OCR) to determine data in the electronic document, identifying key fields in the data, identifying values in the data, or a combination thereof. Creating datasets based on at least partially unstructured electronic documents is described further herein below with respect to FIG. 4.

At S320, the datasets are analyzed. In an embodiment, analyzing each dataset may include, but is not limited to, determining transaction parameters such as, but not limited to, at least one enterprise identifier (e.g., a consumer enterprise identifier, a merchant enterprise identifier, or both), information related to the transaction (e.g., a date, a time, a price, a type of good or service sold, etc.), or both. In a further embodiment, analyzing each dataset may also include identifying the transaction based on the dataset.

At S330, a template is created based on each analyzed dataset. The template may be, but is not limited to, a data structure including a plurality of fields. The fields may include the identified transaction parameters. The fields may be predefined.

Creating templates from electronic documents allows for faster processing due to the structured nature of the created templates. For example, query and manipulation operations may be performed more efficiently on structured datasets than on datasets lacking such structure. Further, organizing information from electronic documents into structured datasets, the amount of storage required for saving information contained in electronic documents may be significantly reduced. Electronic documents are often images that require more storage space than datasets containing the same information. For example, datasets representing data from 100,000 image electronic documents can be saved as data records in a text file. A size of such a text file would be significantly less than the size of the 100,000 images.

At S340, an entity and a time indicated in the transaction electronic document are identified. In an embodiment, the entity and time may be identified based on corresponding fields of the created template. As a non-limiting example, the entity may be indicated in a “supplier identification number” field of the template and the time may be indicated in a “date of transaction” field of the template.

At S350, an evidencing electronic document is obtained based on the identified entity and time. In an embodiment, S350 includes identifying an electronic document indicating the identified entity, the identified time, and an entity status. In a further embodiment, the identified electronic document may be retrieved, or a screenshot of an image illustrating the electronic document may be captured.

At S360, based on the obtained evidencing electronic document, a status of the identified entity is determined. Determining the status of the identified entity may include analyzing the evidencing electronic document. If the evidencing electronic document is an image-based electronic document, the analysis may further include using machine imaging on the evidencing electronic document. In another embodiment, S360 may include generating a status identifier indicating the determined status.

The determined status may demonstrate whether the identified entity was an authentic entity as of the identified time. The entity may be authentic if the entity was in existence, registered for at least one required registration, or both, at the time of the transaction. To this end, in an embodiment, the generated status identifier may be or may include at least one of: existing, non-existing, registered, unregistered, and the like.

In an embodiment, S360 may include creating a template for the evidencing electronic document. In a further embodiment, the evidencing electronic document template may be created based on status evidence parameters indicated in the evidencing electronic document as well as a predetermined set of key fields and values for status-indicating evidencing electronic documents. The status may be determined based on a status evidence parameter in a “status” field of the created evidencing electronic document template.

At S370, the evidencing electronic document, the status identifier, or both, may be stored in a storage. Storing the evidencing electronic document with the status identifier may be useful for, e.g., providing convenient access to the status at a given time along with proof of the status.

At S380, it may be determined whether additional statuses are to be determined and, if so, execution continues with S310 for a new transaction electronic document. Determining status for multiple electronic documents may be utilize for batch processing of, e.g., invoices that are scanned by employees of a company around the same time.

FIG. 4 is an example flowchart S310 illustrating a method for creating a dataset based on an electronic document according to an embodiment.

At S410, the electronic document is obtained. Obtaining the electronic document may include, but is not limited to, receiving the electronic document (e.g., receiving a scanned image) or retrieving the electronic document (e.g., retrieving the electronic document from a consumer enterprise system, a merchant enterprise system, or a database).

At S420, the electronic document is analyzed. The analysis may include, but is not limited to, using optical character recognition (OCR) to determine characters in the electronic document.

At S430, based on the analysis, key fields and values in the electronic document are identified. The key field may include, but are not limited to, merchant's name and address, date, currency, good or service sold, a transaction identifier, an invoice number, and so on. An electronic document may include unnecessary details that would not be considered to be key values. As an example, a logo of the merchant may not be required and, thus, is not a key value. In an embodiment, a list of key fields may be predefined, and pieces of data that may match the key fields are extracted. Then, a cleaning process is performed to ensure that the information is accurately presented. For example, if the OCR would result in a data presented as “1211212005”, the cleaning process will convert this data to 12/12/2005. As another example, if a name is presented as “Mo$den”, this will change to “Mosden”. The cleaning process may be performed using external information resources, such as dictionaries, calendars, and the like.

In a further embodiment, it is checked if the extracted pieces of data are completed. For example, if the merchant name can be identified but its address is missing, then the key field for the merchant address is incomplete. An attempt to complete the missing key field values is performed. This attempt may include querying external systems and databases, correlation with previously analyzed invoices, or a combination thereof. Examples for external systems and databases may include business directories, Universal Product Code (UPC) databases, parcel delivery and tracking systems, and so on. In an embodiment, S430 results in a complete set of the predefined key fields and their respective values.

At S440, a structured dataset is generated. The generated dataset includes the identified key fields and values.

At S450, it is determined if structured datasets for additional transactions are to be created and, if so, execution continues with S410; otherwise, execution terminates.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for determining an entity status based on at least partially unstructured electronic documents, comprising:
analyzing a transaction electronic document to determine at least one transaction parameter for the transaction electronic document, wherein the transaction electronic document includes at least partially unstructured data;
creating a template for the transaction electronic document, wherein the template is a structured dataset including the determined at least one transaction parameter;
obtaining, based on the created template, an evidencing electronic document, wherein the evidencing electronic document at least indicates a status of an entity indicated in the transaction electronic document at a time indicated in the electronic document; and
determining, based on the obtained evidencing electronic document, the status of the entity, wherein the determined status indicates whether the entity was authentic at the time indicated in the electronic document.

2. The method of claim 1, wherein determining the at least one transaction parameter for the transaction electronic document further comprises:
identifying, in the transaction electronic document, at least one key field and at least one value;
creating, based on the transaction electronic document, a dataset, wherein the created dataset includes the at least one key field and the at least one value; and
analyzing the created dataset, wherein the at least one transaction parameter is determined based on the analysis.

3. The method of claim 2, wherein identifying the at least one key field and the at least one value further comprises:
analyzing the transaction electronic document to determine data in the transaction electronic document; and
extracting, based on a predetermined list of key fields, at least a portion of the determined data, wherein the at least a portion of the determined data matches at least one key field of the predetermined list of key fields.

4. The method of claim 3, wherein analyzing the transaction electronic document further comprises:
performing optical character recognition on the transaction electronic document.

5. The method of claim 1, wherein obtaining the evidencing electronic document further comprises:
identifying, based on the created template, an entity identifier and a time identifier; and
identifying the evidencing electronic document in a data source, the evidencing electronic document indicating at least the entity identifier, the time identifier, and an indicator of the status of the entity at the time indicated in the electronic document.

6. The method of claim 5, wherein obtaining the evidencing electronic document further comprises at least one of: retrieving the evidencing electronic document from the data source, and capturing an image illustrating the evidencing electronic document.

7. The method of claim 5, wherein determining the status of the entity further comprises:
generating a status identifier indicating the status of the entity.

8. The method of claim 7, further comprises:
storing, in a storage, at least one of: the obtained evidencing electronic document, and the generated status identifier.

9. The method of claim 1, wherein the transaction electronic document is a scanned invoice, wherein the entity is a supplier indicated in the invoice, wherein the status is any one of: an authentic value-added tax reclaim merchant at the time indicated in the electronic document, and not an authentic value-added tax reclaim merchant at the time indicated in the electronic document.

10. A non-transitory computer readable medium having stored thereon instructions for causing a processing circuitry to perform a process, the process comprising:
analyzing a transaction electronic document to determine at least one transaction parameter for the transaction electronic document, wherein the transaction electronic document includes at least partially unstructured data;
creating a template for the transaction electronic document, wherein the template is a structured dataset including the determined at least one transaction parameter;
obtaining, based on the created template, an evidencing electronic document, wherein the evidencing electronic document at least indicates a status of an entity indicated in the transaction electronic document at a time indicated in the electronic document; and
determining, based on the obtained evidencing electronic document, the status of the entity, wherein the determined status indicates whether the entity was authentic at the time indicated in the electronic document.

11. A system for determining an entity status based on at least partially unstructured electronic documents, comprising:
a processing circuitry; and
a memory, the memory containing instructions that, when executed by the processing circuitry, configure the system to:
analyze a transaction electronic document to determine at least one transaction parameter for the transaction electronic document, wherein the transaction electronic document includes at least partially unstructured data;
create a template for the transaction electronic document, wherein the template is a structured dataset including the determined at least one transaction parameter;
obtain, based on the created template, an evidencing electronic document, wherein the evidencing electronic document at least indicates a status of an entity indicated in the transaction electronic document, at a time indicated in the electronic document; and
determine, based on the obtained evidencing electronic document, the status of the entity, wherein the determined status indicates whether the entity was authentic at the time indicated in the electronic document.

12. The system of claim 11, wherein the system is further configured to:
identify, in the transaction electronic document, at least one key field and at least one value;
create, based on the transaction electronic document, a dataset, wherein the created dataset includes the at least one key field and the at least one value; and
analyze the created dataset, wherein the at least one transaction parameter is determined based on the analysis.

13. The system of claim 12, wherein the system is further configured to:
analyze the transaction electronic document to determine data in the transaction electronic document; and
extract, based on a predetermined list of key fields, at least a portion of the determined data, wherein the at least a portion of the determined data matches at least one key field of the predetermined list of key fields.

14. The system of claim 13, further comprising:
an optical character recognition processor, wherein the system is further configured to:
analyze, by the optical character recognition processor, the transaction electronic document to identify data in the transaction electronic document, wherein the at least one transaction parameter is determined based on the identified data of the transaction electronic document.

15. The system of claim 11, wherein the system is further configured to:
identify, based on the created template, an entity identifier and a time identifier; and
identify the evidencing electronic document in a data source, the evidencing electronic document indicating at least the entity identifier, the time identifier, and an indicator of the status of the entity at the identified time indicated in the electronic document.

16. The system of claim 15, wherein the system is further configured to perform at least one of: retrieving the evidencing electronic document from the data source, and capturing an image illustrating the evidencing electronic document.

17. The system of claim 15, wherein the system is further configured to:
generate a status identifier indicating the status of the entity.

18. The system of claim 17, wherein the system is further configured to:
store, in a storage, at least one of: the obtained evidencing electronic document, and the generated status identifier.

19. The system of claim 11, wherein the transaction electronic document is a scanned invoice, wherein the entity is a supplier indicated in the invoice, wherein the status is any one of: an authentic value-added tax reclaim merchant at the time indicated in the electronic document, and not an authentic value-added tax reclaim merchant at the time indicated in the electronic document.

20. The system of claim 11, wherein the determined status is at least one of: registered for reclaims, unregistered for reclaims, existing, and non-existing.
